(19) United States
(12) Patent Application Publication
(10) Pub. No.: US 2011/0139523 A1
(43) Pub. Date: Jun. 16, 2011

(54) IN-WHEEL MOTOR STRUCTURE

(76) Inventor: Ze-Chun CHEN, Taitung County (TW)

(21) Appl. No.: 12/637,344

(22) Filed: Dec. 14, 2009

(51) Int. Cl. B60K 1/00; H02K 7/14

(52) U.S. Cl. 180/65.51; 310/67 R

(57) ABSTRACT

An improved in-wheel motor structure comprising a stator, integrating to a car frame fixing arm as one unit; a rotor, assembling with a wheel frame of the wheel as one unit; a shaft, integrating with the rotor as one unit, wherein the shaft and rotor is then connected to an engine driving shaft via a transmission unit integrally; and a plurality of bearings, locating between an inner side of the stator and the shaft of the rotor so that the rotor is rotated by using the stator as a central point of rotation. The improved in-wheel motor structure is utilized in the hybrid electric power to drive a wheel.

### FIELD OF THE INVENTION

The present invention relates to an in-wheel motor structure, and more particularly to an improved in-wheel motor structure that uses the hybrid electric vehicle (HEV) to drive a wheel.

### BACKGROUND OF THE INVENTION

The hybrid electric vehicle (HEV) combines a conventional internal combusting engine propulsion system with an electric propulsion system. When car initiates, the engine speed is very lower that the rotation driving is insufficient. Therefore, the car is normally relied on electrical motor to provide the supplemental electrical power for the engine. When the rotation speed of the engine is fast enough, the supplemental electrical power of the electrical motor is stop to supply and the car is driven solely by the engine in order to reduce the consumption of the fuel and decrease on the cost so that the high performance and low cost demand can be achieved in the modern vehicle. The increasing in oil price in recent years plus the change in the climate, countries around the world are working together to combat the environmental issues. High performance and environmental friendly vehicles are increasing important in the globe markets.

FIG. 1 shows a schematic view of a conventional design of in-wheel motor structure, the in-wheel motor 10 comprises a wheel frame 20 assembly integrally with a rotor 11 and a stator 12, wherein a plurality of bearings 13 are located between the inner side of the rotor 11 and the central axis 15 of the stator 12 so that a control cable 14 is assembled and penetrated through to the central axis 15 of the stator 12 in order to provide the electrical power required for rotating the rotor 11 and the wheel frame 20 so the electrical power car can be moved.

This type of in-wheel motor 10 for the hybrid electric vehicle (HEV) is normally installed at the front wheel of the car not the rear wheel because the space is taken by the engine and transmission box. As a result, the conventional in-wheel motor 10 cannot be installed at rear wheel of the vehicle. However, for the vehicle to use the front wheel for the electrical driving and the rear wheel for the combusting engine propulsion system, the complexity of the vehicle is difficult regulated by legal testing and the front wheel electrical driving can cause the user difficult to handle the vehicle comfortably.

### SUMMARY OF THE INVENTION

In view of the foregoing shortcomings of the conventional designs, the present invention provides an improved in-wheel motor used for HEV car.

The improved in-wheel motor structure of the present invention comprises a stator, integrating to a car frame fixing arm as one unit; a rotor, assembling with a wheel frame of the wheel as one unit; a shaft, integrating with the rotor as one unit, wherein the shaft and rotor is then connected to an engine driving shaft via a transmission unit integrally; and a plurality of bearings, locating between an inner side of the stator and the shaft of the rotor so that the rotor is rotated by using the stator as a central point of rotation. The stator is assembled integrally with the car frame fixing arm as one unit. According to one of preferred embodiments of the present invention, the wheel is a rear wheel and the car frame fixing arm is a rear-wheel frame fixing arm. The improved in-wheel motor structure is designed in such that when the speed of the car is higher than a pre-determined value, the transmission unit will be integrated with the engine driving shaft as one unit.

These features and advantages of the present invention will become more fully apparent from the following description and appended claims, or may be learned by the practice of the invention as set forth thereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawings. Understanding that theses drawings depict only typical embodiments of the invention and are not therefore to be considered to be limiting of its scope, the invention will be described and explained with additional specificity and detail through the use of the accompanying drawings, in which:

FIG. 1 is a perspective view of a conventional structure using for a HEY motor; and

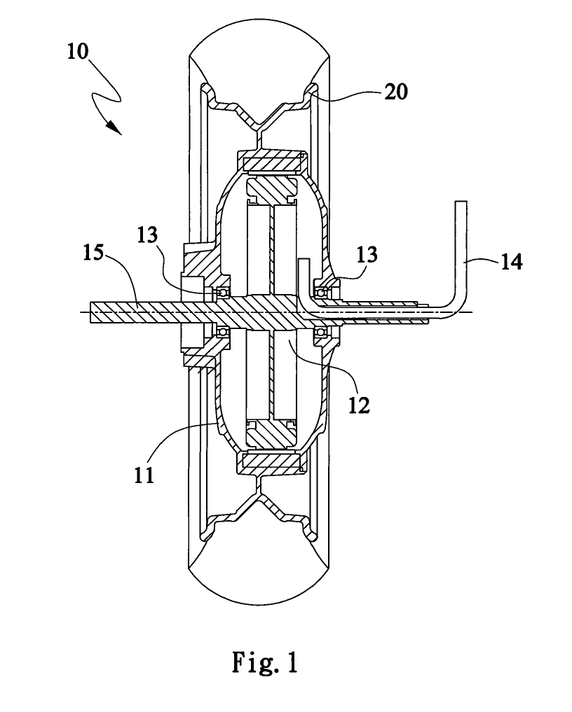

FIG. 2 is a perspective view of an improved in-wheel motor in accordance with a preferred embodiment of the present invention.

### DETAILED DESCRIPTION OF THE PREFERRED EMBODIMENTS

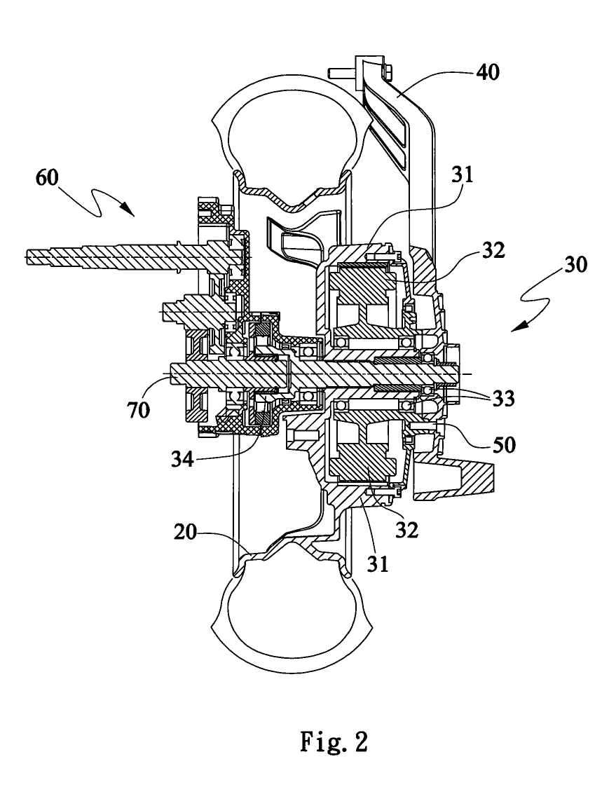

Refer to FIG. 2, a schematic view of an improved HEV motor in accordance with a preferred embodiment of the present invention. The improved in-wheel motor 30 of the present invention is used to drive a wheel and can work with the engine of the car to drive the wheels of the car. For HEV automobile, the in-wheel motor 30 can drive the front wheels or the rear wheels wherein the in-wheel motor 30 comprises a stator 32 and a rotor 31 and a plurality of bearings 33 and a shaft 34. The stator 32 is assembled integrally with a car frame fixing arm 40 of the car via a plurality of fixed units 50 (such as, screws or rivets) as one body. The car frame fixing arm 40 can be used for the front part or the rear part of the car to position the stator 32 at its location inside the car. The rotor 31 and a wheel frame 20 of the car are integrally assembled so that when the rotor 31 is rotating during driving, the wheel frame 20 will be driven to rotate. The shaft 34 and the rotor 31 are integrated together, and the assembly of the shaft 34 and the rotor 31 is then connected to an engine driving shaft 70 via a transmission unit 60 integrally. The bearings 33 are located between the inner side of the stator 32 and the shaft 34 of the rotor 31 so that the stator 32 is utilized as a central point of rotation of the rotor 31, therefore, when rotor 31 is rotated by utilizing the stator 32 as the central point, the rotor 31 will not come in contact with the stator 32 so that the energy consumption is drastically reduced. The stator 32 is coupled to a control cable (not shown) in order to control the required electrical power of the rotation movement for the rotor 31.

When the speed of the car is lower than a pre-determined valve (such as 40 km/h), the engine will utilize the control cable to transmit the electrical power as the driving power source for power efficiency. The rotor 31 of the in-wheel motor 30 of the car is driven by the electrical power to rotate the shaft 34 and the wheel frame 20 during the driving. When the speed of the car is higher than the pre-determined value, the car will switch to the engine power as the driving power source for car. In such case, the transmission unit 60 will be integrated with the engine driving shaft 70 and the shaft 34 to rotate the shaft 34 via the engine driving shaft 70 in order for the car to move. The engine of the car utilizes the transmission unit 60 and the engine driving shaft 70 to rotate the shaft 34 so that the rotor 31 and the wheel frame 20 will be rotated by the shaft 34. The in-wheel motor drives the wheel frame 20 via the rotor 31. Therefore, the improved in-wheel motor 30 can utilize the hybrid electric power to drive a wheel.

According to one of preferred embodiments of the present invention, the car frame fixing arm 40 is utilized as a rear-wheel frame fixing arm, the in-wheel motor 30 of the present invention is then located at the rear side of the car. Thus, the car is driving by the rear wheels of the car. The user does not need to re-adjust the driving feeling. Since the improved in-wheel motor is designed according to the vehicle regulations, therefore, the car can be driven easily without any of the drawback of the conventional design.

For the purpose of promoting an understanding of the principles of the invention, reference will now be made to the exemplary embodiments illustrated in the drawings, and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

What is claimed is:

1. An improved in-wheel motor structure, used for driving a wheel, comprising:
a stator, integrating to a car frame fixing arm as one unit;
a rotor, assembling with a wheel frame of the wheel as one unit;
a shaft, integrating with the rotor as one unit, wherein the shaft and rotor is then connected to an engine driving shaft via a transmission unit integrally; and
a plurality of bearings, locating between an inner side of the stator and the shaft of the rotor so that the rotor is rotated by using the stator as a central point of rotation.

2. The improved in-wheel motor structure of claim 1, wherein the stator is assembled integrally with the car frame fixing arm as one unit.

3. The improved in-wheel motor structure of claim 1, wherein the wheel is a rear wheel and the car frame fixing arm is a rear-wheel frame fixing arm.

4. The improved in-wheel motor structure of claim 1, when the speed of the car is higher than a pre-determined value, the transmission unit will be integrated with the engine driving shaft as one unit.
